(19) United States
(12) Patent Application Publication
(10) Pub. No.: US 2016/0278162 A1
(43) Pub. Date: Sep. 22, 2016

(54) VEHICLE HEATING SYSTEM

(71) Applicant: IEE INTERNATIONAL ELECTRONICS & ENGINEERING S.A., Echternach (LU)

(72) Inventors: Andreas PETEREIT, Schweich (DE); Christoph WENDT, Mettendorf (DE)

(21) Appl. No.: 15/031,171

(22) PCT Filed: Oct. 20, 2014
(86) PCT No.: PCT/EP2014/072387

§ 371 Date: Apr. 21, 2016

(30) Foreign Application Priority Data
Oct. 22, 2013 (LU) 92 297

(51) Int. Cl. H05B 1/02; B60H 1/00

(52) U.S. Cl. CPC H05B 1/0236; H05B 1/0202; B60H 1/00271; B60H 1/00642

(57) ABSTRACT

A vehicle heating system that includes a heating element and a power source for providing an electrical power to the heating element. Furthermore, the vehicle heating system includes a control unit, which is operatively coupled to the power source and/or the heating element. The control unit is adapted to regulate the electrical power to be supplied to the heating element over time and the control unit is configured to regulate the electrical power by modifying a DC voltage supply U_{supply} supplied to the heating element over time. The heat provided by the heating element is preferably in linear relationship with the DC voltage supply U_{supply} supplied to the heater.

### TECHNICAL FIELD

The present invention generally relates to a vehicle heating system. More specifically the invention relates to a vehicle heating system that is controlled by a DC (direct current) voltage supply provided by a control unit.

### BACKGROUND ART

Driving heating elements, such as seat heater elements, with pulse width modulated (PWM) currents is a standard in today's automotive industry. Heating elements more particularly seat heaters are turned “ON” or “OFF” in relation to the pulsed current supplied to the heating element by the control unit. The control unit most commonly comprises a semiconductor switch that switches between the “ON” state and the “OFF” state at a predefined switching frequency. The longer the width of the pulse or the more often (in a set time interval) the amplitude of the PWM current is provided, the more electrical power is delivered in average to the heating element and consequently the more heat is generated.

A disadvantage of pulse width modulated signals is the generation of high frequency waves due to the quick switching between the “ON” state and the “OFF” state. DE patent application DE 10 2008 022 048 A1 reveals a method for creating a slower rise of the heating current for generating less high frequency waves which generate less electro magnetic alternating fields. Even if the magnitude of such electro magnetic alternating fields can be kept low by the method as described in the patent application DE 10 2008 022 048 A1, heaters that are driven by pulse width modulated currents still suffer from other problems.

In particular the relation between the amplitude of the pulsed width modulated current, the voltage of the pulse width modulated signal and the resistance of the heating element is problematic for vehicle systems with a low-voltage power source. Most frequently cars have low-voltage batteries (such as, e.g. 12 V batteries), which require low ohm heaters for providing the needed power. This implies high current pulses and hence thick connectors, thick cabling and in cases of printed heaters a lot of silver ink to maintain the high current density. Furthermore, the high current required for driving the heater may prevent the energy management system to drive other loads connected to the energy management system in parallel to the heater. In the seat environment for instance, the energy management system is usually not sufficiently powerful to be able to drive the motors for seat positioning and the seat heater simultaneously. In consequence the seat heater has to be turned off during seat positioning.

Even though pulse width modulation is a convenient way to power vehicle heating systems, there still is a need to provide optimized vehicle heating systems where the quantity and the quality of the required materials can be reduced and where other electrical loads, which are connected to the energy management system, can be driven simultaneously.

### SUMMARY

It is an object of the present invention to provide an optimized vehicle heating system, preferably of reduced costs.

The present invention relates to a vehicle heating system that, in at least some embodiments, comprises a heating element and a power source for providing an electrical power to the heating element, which preferably is a foil based seat heater. Furthermore, the vehicle heating system comprises a control unit, which is operatively coupled to the power source and/or the heating element. The control unit is adapted to regulate the electrical power to be supplied to the heating element over time. The control unit is configured to regulate the electrical power by modifying a DC (direct current) voltage supply U_{supply} supplied to the heating element over time. The heat provided by the heating element is in a defined relationship with the DC voltage supply U_{supply} supplied to the heater. By controlling the voltage with the control unit, the total heating power may be efficiently regulated without the above described negative side effects of the pulse width modulation.

The power source preferably is a battery such as for example a lithium ion battery, a lithium polymer battery, a lead acid battery, an alternator or a power output of a driving ECU (electric control unit), having a DC voltage of approximately 12 V. In operation, the current provided by the battery is substantially constant over time.

According to a preferred embodiment of the invention, the control unit comprises a DC/DC converter for receiving an input DC with an input DC voltage Uᵢₙ from the power source and providing an output DC supply with an output DC voltage supply U_{supply} to the heating element for powering the heating element.

Advantageously for high power operation i.e. if high heating power is required, the DC/DC converter converts the input DC voltage Uᵢₙ into the output DC voltage supply U_{supply} such that U_{supply}>Uᵢₙ. Thanks to the higher output DC voltage, the current to be provided to the heater element in order to obtain a defined heating power may be efficiently reduced. This enables for instance the use of dedicated heater designs. Preferably, high resistive heaters and conductors are used, such as for example foil based printed heaters with a reduced amount of silver ink. Alternatively, foil based heaters with carbon ink can be used.

Furthermore a connector of the heating element for connecting the heating element to the control unit can have less cross section. In result less copper, brass or other conductive material is used. The housing of the control unit can be dimensioned smaller and less material is required, which results in lower costs. Furthermore the cabling from the control unit to the heating element can be thinner and is thus cheaper and more flexible. Finally since only low peak currents are provided to the heater and the energy system of the car, different components, such as, e.g. the alternator and the harness can be dimensioned more cost efficiently. Furthermore, as the size of different electrical components can be lower rated, the weight of the car is reduced.

The skilled person will appreciate that if a lower heating power is required, the DC/DC converter is preferably controlled so as to convert the input DC voltage Uᵢₙ into the output DC voltage supply U_{supply} such that U_{supply}<Uᵢₙ or U_{supply}=Uᵢₙ.

The control unit preferably comprises a microcontroller operatively coupled to the DC/DC converter for regulating the output DC voltage supply U_{supply}, supplied by the DC/DC converter.

According to a preferred embodiment of the invention, the control unit comprises at least one interface for receiving energy management information from an energy management unit. The energy management unit may comprise at least one interface, such as, for example a LIN (local interconnect network) interface. The at least one LIN interface can be operationally coupled with another LIN interface, such as for example the LIN interface of an ECU. In this preferred embodiment, the LIN interface of the energy management unit is coupled to a LIN interface of the microcontroller.

Advantageously at least one temperature sensor is operatively connected to the energy management unit for providing environment condition information, such as the air temperature Tₐᵢᵣ inside the vehicle.

Preferably, the energy management unit receives energy management information from input information. The term “input information” refers to an input that is provided by a user. A temperature regulator such as a rotary button or a switch can be operatively coupled to the energy management unit. The user can input the desired temperature level by adjusting the temperature regulator. In consequence the output voltage supply U_{supply} may be regulated according to the position of the level or the temperature set.

Advantageously, the microcontroller regulates the output DC voltage supply U_{supply} based on the energy management information.

### BRIEF DESCRIPTION OF THE DRAWINGS

A preferred embodiment of the invention will now be described, by way of example, with reference to the accompanying drawing in which:

FIG. 1 is a schematic view of a vehicle heating system in accordance with the invention.

### DESCRIPTION OF THE ILLUSTRATED EMBODIMENT(S)

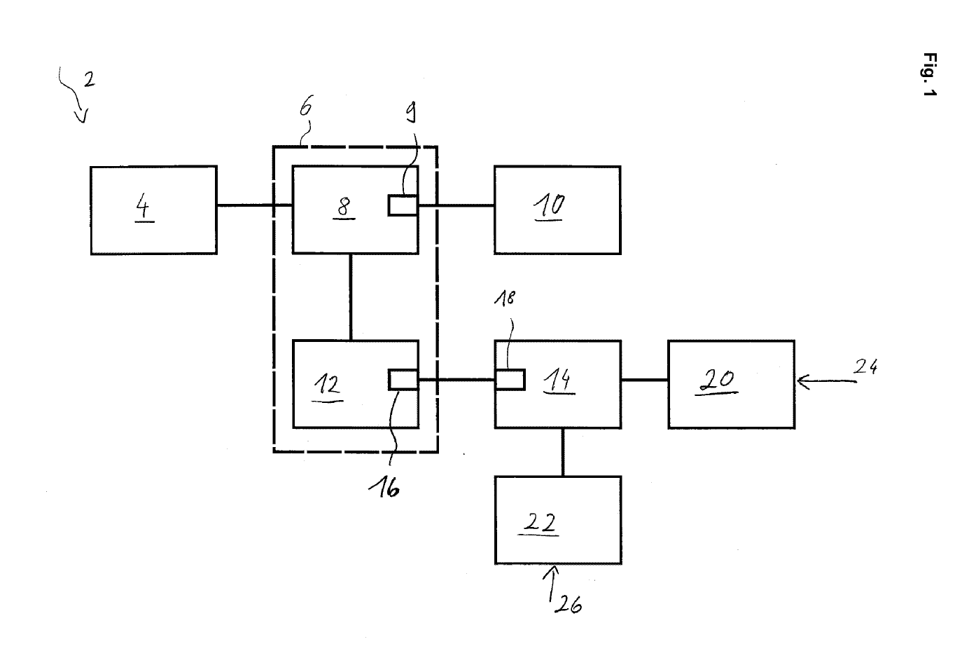

The vehicle heating system 2 according to the embodiment of FIG. 1 has a power source 4 that generates a direct current DC with an electrical power Pᵢₙ. In this particular preferred embodiment of the invention, the power source can be 12 V lithium ion battery, a lithium polymer battery, a lead-acid battery or an alternator. The electrical power Pᵢₙ with an input voltage Uᵢₙ of 12 V and an input current Iᵢₙ, is being inputted to a DC/DC converter 8 of a control unit 6. The DC/DC converter 8 outputs an output voltage supply U_{supply} between 3 V to 40 V to the foil based seat heater 10.

For instance, for high power operation i.e. if high heating power is required, the output voltage supply U_{supply} is greater than the voltage of the input DC Uᵢₙ. On the other hand, for low power operation, i.e. if a lower heating power is required, the output voltage supply U_{supply} may be adjusted to values which are lower than the 12 V input voltage Uᵢₙ.

The course of the output voltage supply U_{supply} and the course of the supply current I_{supply} are not pulsed over time but preferably continuous in operation. In comparison to DE 10 2008 022 048 A1, no PWM (pulse width modulation) is used for powering the foil based seat heater. The amount of heat generated by the foil based seat heater 10 is related to the magnitude of the output voltage supply U_{supply}. The foil based seat heater 10 is preferably a high resistive foil based heater with silver ink printed conductors and a connector 9. The foil based seat heater is connected via connector 9 to the PCB (printed circuit board) of the control unit 6. The temperature Tₕₑₐₜ generated by the foil based seat heater 10 is related to the output DC voltage supply U_{supply} provided by the DC/DC converter 8. The higher the output voltage supply U_{supply} of the output DC the more heat is generated by the foil based seat heater 10 and the higher rises the temperature Tₕₑₐₜ. The electrical power of the input DC Pᵢₙ is substantially equal to the electrical power of the output DC supply P_{supply}. In consequence, an increase in voltage (U_{supply}>Uᵢₙ) results in a decrease in current (I_{supply}<Iᵢₙ) The maximum heating temperature Tₕₑₐₜ can be controlled by using a foil heater having a PTC (positive temperature coefficient) material as heating element. For PTC foil heaters the resistance of the foil heaters increases with the temperature until a maximum temperature is reached. If a constant voltage is applied to the PTC material, the resistance of the heating element increases and as a result the heating current decreases. The maximum temperature can thus be limited by a PTC foil heater.

The control unit comprises a microcontroller 12 that is operationally coupled to the DC/DC converter for regulating the output voltage supply U_{supply}. The magnitude of the output voltage U_{supply} is based on energy management information such as environment condition information 26 and user input information 24. The term “environment condition information” refers to one or more inputs provided by nature or any measurable external and/or internal physical quantities at the interior or the exterior of the car. In this particularly preferred embodiment of the invention such environment condition information 26 is provided by the air temperature Tₐᵢᵣmeasured by a temperature sensor operatively connected to the energy management control unit. Alternatively or additionally the energy management unit can be connected to the driving ECU of the vehicle to receive additional environment condition information 26 provided by sensors operatively coupled to the driving ECU. Input information 24 refers to one or more inputs provided by the user, such as for example the desired temperature level T_{desired}. A temperature regulator 22 can be operationally coupled to the energy management unit 14 for inputting the desired temperature level. The energy management unit is preferably connected via a LIN-connection (Local Interconnect Network) to the LIN-interface 16 of the microcontroller 12.

Furthermore, as a consequence of the linear relationship between heat generated by the foil based seat heater 10 and the output voltage supply U_{supply}, other electrical loads, such as motors for seat positioning can be operated simultaneously with the foil based seat heater 10.

1. A vehicle heating system comprising:
a heating element,
a power source for providing an electrical power to said heating element, and
a control unit operationally coupled to said power source and/or said heating element, wherein said control unit is adapted to regulate said electrical power to be supplied to said heating element over time,
wherein said control unit is configured to regulate said electrical power by modifying a DC voltage supply U_{supply} supplied to said heating element over time.

2. Vehicle heating system according to claim 1, wherein said control unit comprises a DC/DC converter for receiving an input DC with an input DC voltage Uᵢₙ from said power source and providing an output DC supply with an output DC voltage supply U_{supply} to said heating element for powering said heating element.

3. Vehicle heating system according to claim 1, wherein said DC/DC converter converts said input DC voltage Uᵢₙ into said output DC voltage supply U_{supply} such that U_{supply}>Uᵢₙ.

4. Vehicle heating system according to claim 1, wherein said control unit comprises a microcontroller operationally coupled to said DC/DC converter for regulating said output DC voltage supply U_{supply} by said microcontroller.

5. Vehicle heating system according to claim 1, wherein said control unit comprises at least one interface for receiving energy management information from an energy management unit.

6. Vehicle heating system according to claim 5, wherein said energy management unit receives energy management information comprising environment condition information and/or user input information.

7. Vehicle heating system according to claim 5, wherein said microcontroller regulates said output DC voltage supply U_{supply} based on said energy management information.

8. Vehicle heating system according to claim 1, wherein said heating element is a foil based heater and/or a printed heater.
